(19) United States
(12) Patent Application Publication
(10) Pub. No.: US 2016/0054712 A1
(43) Pub. Date: Feb. 25, 2016

(54) COMBINED STATISTICAL AND PHYSICS BASED MODEL CONTROL AND PERFORMANCE METHOD AND SYSTEM

(71) Applicant: Siemens Industry, Inc., Alpharetta, GA (US)

(72) Inventors: Norman R. McFarland, Palatine, IL (US); Osman Ahmed, Hawthorn Woods, IL (US)

(73) Assignee: SIEMENS INDUSTRY, INC., Alpharetta, GA (US)

(21) Appl. No.: 14/466,419

(22) Filed: Aug. 22, 2014

(51) Int. Cl. G05B 13/04; H04L 12/28

(52) U.S. Cl. CPC G05B 13/04; H04L 12/2803

(57) ABSTRACT

An approach for statistically modeling a room or building in a building automation system to provide fault detection and diagnostics and economic optimization of the building automation system using statistical data.

### FIELD OF THE INVENTION

This application relates generally to the field of building automation systems, and more particularly to the control and monitoring of building automation systems using statistical and physical based modeling.

### BACKGROUND

Building automation systems typically gather real-time data of building systems and present the information at an operations and maintenance center (OMC) so that an operator may monitor and control a building or facility. Examples of the real-time data that may be collected include operational states, events, alarms, and environmental sensor data, such as temperature, humidity, and light. This real-time data along with configuration data, i.e., data related to lights, thermostats, damper actuators, alarms, heating, ventilation, and air conditioning (HVAC) devices, sprinkler systems, speakers, door locks, and the like, may be stored in databases that are accessed by the OMC and displayed on a display. In general, a building automation system (BAS) generates and displays all of the information needed to monitor and control a building or facility and portions thereof.

Currently, real-time data that is gathered may be saved in logs that are reviewable at later times, but typically faults are detected only when alarms are generated by devices or sensors located in the building automation system. Logs may be examined to identify trends after the fact, but the trends are based on past performance and not the current operational data and environment.

Therefore, what is needed in the art is an approach that is more predictive of changes that are occurring in a BAS.

### SUMMARY

In accordance with one embodiment of the disclosure, a building automation system (BAS) for a building is described comprising a controller that accesses a database having data associated with a plurality of BAS devices and a plurality of areas in the building. Rather than just measuring air flow and temperature in a room or area covered by the BAS, the energy characterizations of the room or area are modeled and statistical approaches are applied to the model. The modeling of the room or area enables faults to be detected, energy use for the room or area to be optimized and statistical approaches to be used to detect and diagnose faults before they occur, statistically optimize the energy use, and control the BAS based upon statistical analysis.

What is described is a building automation system (BAS) that employs a first plurality of data received by a processor in the BAS, where the first plurality of data is associated with a room that is serviced by the BAS with a first set of point values for the room. A room model for the room is stored in a memory in the BAS, where the room model is based upon the first plurality of data and results in statistical parameters when the first plurality of data is applied to the room model and a second set of point values generated in response to the statistical parameters.

What is also being described is a method of adjusting a BAS. The BAS receives a first plurality of data at a processor in the BAS, where the first plurality of data is associated with a room that is serviced by the BAS with a first set of point values for the room. The BAS generates a room model for the room based upon the first plurality of data and results in statistical parameters when the first plurality of data is applied to the room model and stored in a memory of the BAS, where the BAS also generates a second set of point values by the processor in response to the statistical parameters.

The above described features and advantages, as well as others, will become more readily apparent to those of ordinary skill in the art by reference to the following detailed description and accompanying drawings. The graphical information in the BAS teachings disclosed herein extend to those embodiments that fall within the scope of the appended claims, regardless of whether they accomplish one or more of the above-mentioned advantages.

### BRIEF DESCRIPTION OF THE DRAWINGS

FIG. 1 shows an exemplary topology diagram for a building automation (BAS) system having an environmental control access panel;

FIG. 2 shows an exemplary block diagram of a BAS of the building network of FIG. 1;

FIG. 3 shows an exemplary internal block diagram of a field panel for the BAS of FIG. 2;

FIG. 4 depicts a diagram of a room controlled by the BAS of FIG. 1 in accordance with an example implementation;

FIG. 5 depicts a diagram of a room model of the room shown in FIG. 4 in accordance with an example implementation;

FIG. 6 depicts normalized bell curve plots for statistical variables V_{\dot{R}}, V_{\dot{S}}, T_{S} and T_{R} of FIG. 5 in accordance with an example implementation of the invention;

FIG. 7 depicts a block diagram of a knowledge base module located in the BAS application FIG. 3 in accordance with an example implementation;

FIG. 8 depicts a block diagram of the optimizer module with control box module of FIG. 7; and

FIG. 9 is an illustration of a flow diagram of an approach for generating optimized values for a room having an associated room model in accordance with an example implementation of the invention.

### DESCRIPTION

An example approach for the use of statistical modeling for control of a building automation system (BAS) is presented. In the example, statistical models are employed to provide fault detection and diagnosis information, and optimization of a BAS.

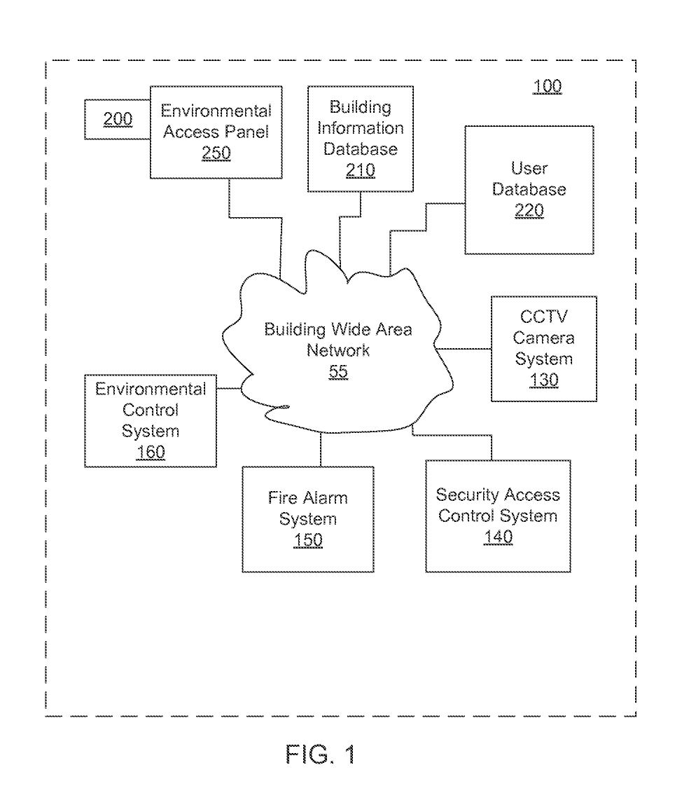

With reference to FIG. 1, an exemplary topology diagram for a BAS is shown. The building wide area network 55 includes a plurality of systems and components in wired or wireless communication. The building wide area network 55 generally includes a plurality of building automation systems 100 and may be accessed via a “building synergistic interface system” or “BSIS”. The BSIS 200 may include access to a data storage device comprising a building information database 210 and a user database 220 that may also be stored in memory 124. Software for communicating environmental and other data to the BSIS 200 may be stored on both a mobile computing device 300 and/or the building automation system 100.

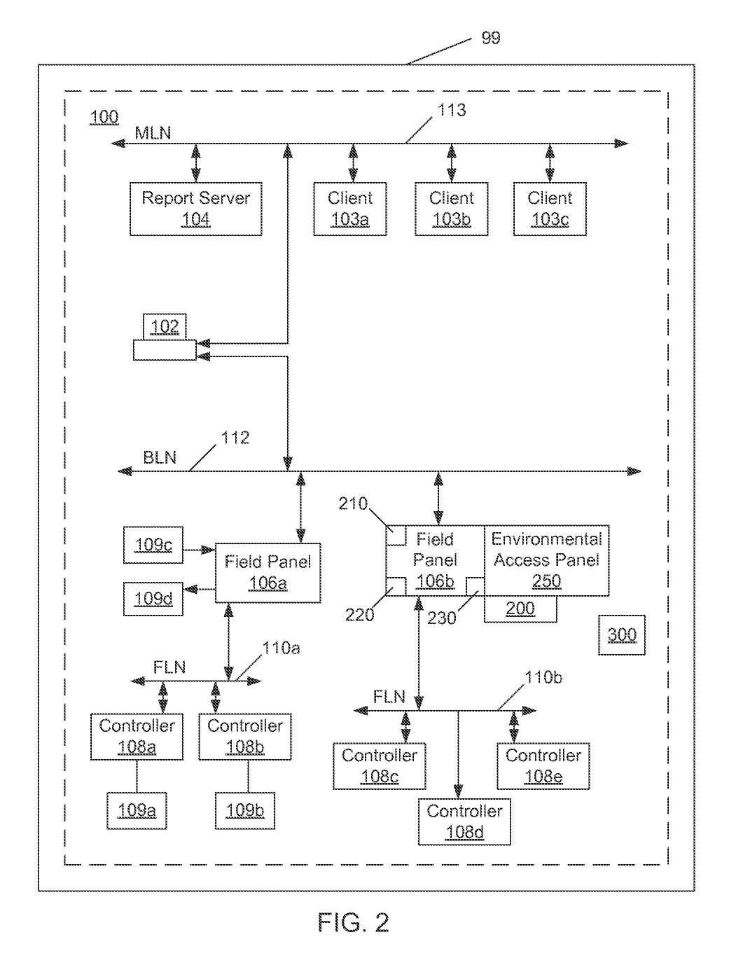

In the following pages, the general arrangement of an exemplary building automation system 100 configured for use with the BSIS 200 is explained first. Thereafter, the general arrangement of the environmental control access panel 250 is explained followed by the generation of a room model and an economic model. In the example embodiment of FIG. 1, the building automation system 100 may include a building information database 210, user database 220, closed circuit television system 130, a security system 140, a fire alarm system 150, and an environmental control system 160. In FIG. 2, a system block diagram of an exemplary building automation system (BAS) 100 within a building 99 is depicted. The building automation system 100 is depicted as a distributed building system that provides control functions for any one of a plurality of building operations, such as environmental control, security, life or fire safety, industrial control and/or the like. An example of a BAS is the Apogee® building automation system available from Siemens Industry, Inc., Building Technologies Division, of Buffalo Grove, Ill. The Apogee® building automation system allows the setting and/or changing of various controls of the system, generally as provided below. While a brief description of an exemplary BAS is provided in the paragraphs below, it should be appreciated that the building automation system 100 described herein is only an exemplary form or configuration for a BAS.

With particular reference to FIG. 2, the BAS 100 includes at least one supervisory control system or workstation 102, client workstations 103a-103c, report server 104, a plurality of field panels represented by field panels 106a and 106b, and a plurality of controllers represented by controllers 108a-108e. It will be appreciated, however, that wide varieties of BAS architectures may be employed.

Each of the controllers 108a-108e represents one of a plurality of localized, standard building control subsystems, such as space temperature control subsystems, lighting control subsystems, or the like. Suitable controllers for building control subsystems include, for example, the model TEC (Terminal Equipment Controller) available from Siemens Industry, Inc., Building Technologies Division, of Buffalo Grove, Ill. To carry out control of its associated subsystem, each controller 108a-108e connects to one or more field devices, such as sensors or actuators, shown by way of example in FIG. 2 as the sensor 109a that is connected to the controller 108a and the actuator 109b that is connected to controller 108b.

Typically, a controller such as the controller 108a affects control of a subsystem based on sensed conditions and desired set point conditions. The controller controls the operation of one or more field devices to attempt to bring the sensed condition to the desired set point condition. By way of example, consider a temperature control subsystem that is controlled by the controller 108a, where the actuator 109b is connected to an air conditioning damper and the sensor 109a is a room temperature sensor. If the sensed temperature as provided by the sensor 109a is not equal to a desired temperature set point, then the controller 108a may further open or close the air conditioning damper via actuator 109b to attempt to bring the temperature closer to the desired set point. It is noted that in the BAS 100, sensor, actuator and set point information may be shared between controllers 108a-108e, the field panels 106a and 106b, the work station 102 and any other elements on or connected to the BAS 100.

To facilitate the sharing of such information, groups of subsystems such as those connected to controllers 108a and 108b are typically organized into floor level networks or field level networks (“FLNs”) and generally interface to the field panel 106a. The FLN data network 110a is a low-level data network that may suitably employ any suitable proprietary or open protocol. Subsystems 108c, 108d and 108e along with the field panel 106b are similarly connected via another low-level FLN data network 110b. Again, it should be appreciated that wide varieties of FLN architectures may be employed.

The field panels 106a and 106b are also connected via building level network (“BLN”) 112 to the workstation 102 and the report server 104. The field panels 106a and 106b thereby coordinate the communication of data and control signals between the subsystems 108a-108e and the supervisory computer 102 and report server 104. In addition, one or more of the field panels 106a, 106b may themselves be in direct communication with and control field devices, such as ventilation damper controllers or the like. To this end, as shown in FIG. 2, the field panel 106a is coupled to one or more field devices, shown for example as a sensor 109c and an actuator 109d.

The workstation (server in other implementations) 102 provides overall control and monitoring of the building automation system 100 and includes a user interface. The workstation 102 further operates as a BAS data server that exchanges data with various elements of the BAS 100. The BAS data server can also exchange data with the report server 104. The BAS data server 102 allows access to the BAS system data by various applications. Such applications may be executed on the workstation 102 or other supervisory computers (not shown).

With continued reference to FIG. 2, the workstation 102 is operative to accept modifications, changes, alterations and/or the like from the user. This is typically accomplished via a user interface of the workstation 102. The user interface may include a keyboard, touch screen, mouse, or other interface components. The workstation 102 is operable to, among other things, affect or change operational data of the field panels 106a, 106b as well as other components of the BAS 100. The field panels 106a and 106b utilize the data and/or instructions from the workstation 102 to provide control of their respective controllers.

The workstation 102 is also operative to poll or query the field panels 106a and 106b for gathering data in client server type implementations. In other implementations, a peer-to-peer communication approach may be employed. The workstation 102 processes the data received from the field panels 106a and 106b, including trending data. Information and/or data is thus gathered from the field panels 106a and 106b in connection with the polling, query or otherwise, which the workstation 102 stores, logs and/or processes for various uses. To this end, the field panels 106a and 106b are operative to accept modifications, changes, alterations and/or the like from the user.

The workstation 102 also preferably maintains a database associated with each field panel 106a and 106b. The database maintains operational and configuration data for the associated field panel. The report server 104 stores historical data, trending data, error data, system configuration data, graphical data and other BAS system information as appropriate. In other embodiments the building information database 210 and a user database 220 may be stored elsewhere, such as field panel 106b.

The management level network (MLN) 113 may connect to other supervisory computers and/or servers, internet gateways, or other network gateways to other external devices, as well as to additional network managers (which in turn connect to more subsystems via additional low level data networks). The workstation 102 may operate as a supervisory computer that uses the MLN 113 to communicate BAS data to and from other elements on the MLN 113. The MLN 113 may suitably comprise an Ethernet or similar wired network and may employ TCP/IP, BACnet, and/or other protocols that support high speed data communications.

FIG. 2 also shows that the BAS 100 may include a field panel 106b that is shown in FIG. 2 as a housing that holds the building information database 210, the user database 220, and the environmental access panel 250 having BSIS 200. For example, the building information database 210 and the user database 220 of the BSIS could be provided on the workstation 102. Alternatively, the building information database 210 and the user database 220 could be housed separately from those components shown in FIG. 2, such as in a separate computer device that is coupled to the building level network 112 or other BAS location. Such a separate computer device could also be used to store BSIS operational software. Similarly, the environmental access panel 250 with BSIS 200 may be housed within the workstation 102 or within a separate computer device coupled to the BAS 112 of the BAS.

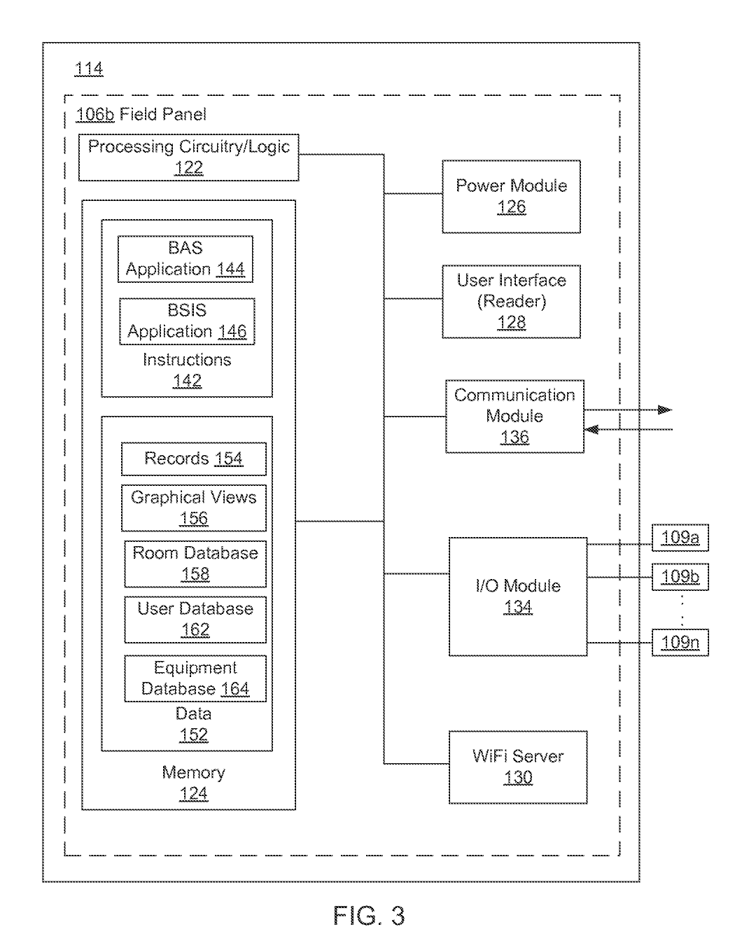

With reference now to FIG. 3, a block diagram of an exemplary embodiment of the field panel 106b of FIG. 2 is shown. It should be appreciated that the embodiment of the field panel 106b is only an exemplary embodiment of a field panel in a BAS 100 coupled to the BSIS 200. As such, the exemplary embodiment of the field panel 106b of FIG. 3 is a generic representation of all manners or configurations of field panels that are operative in the manner set forth herein.

The field panel 106b of FIG. 3 includes a housing, cabinet or the like 114 that is configured in a typical manner for a BAS field panel. The field panel 106b includes processing circuitry/logic 122, memory 124, a power module 126, a user interface 128, an I/O module 134, a BAS network communications module 136, and the WiFi server 130.

The processing circuitry/logic 122 is operative, configured and/or adapted to operate the field panel 106b including the features, functionality, characteristics and/or the like as described herein. To this end, the processing circuitry logic 122 is operably connected to all of the elements of the field panel 106b described below. The processing circuitry/logic 122 (also referred to as a processor) is typically under the control of program instructions or programming software or firmware contained in the instructions 142 area of memory 124, explained in further detail below. In addition to storing the instructions 142, the memory also stores data 152 for use by the BAS 100 and/or the BSIS 200.

The field panel 106b also includes a power module 126 that is operative, adapted and/or configured to supply appropriate electricity to the field panel 106b (i.e., the various components of the field panel). The power module 126 may operate on standard 120 volt AC electricity, but may alternatively operate on other AC voltages or include DC power supplied by a battery or batteries.

An input/output (I/O) module 134 is also provided in the field panel 106b. The I/O module 134 includes one or more input/output circuits that communicate directly with terminal control system devices such as actuators and sensors. Thus, for example, the I/O module 134 includes analog input circuitry for receiving analog sensor signals from the sensor 109a, and includes analog output circuitry for providing analog actuator signals to the actuator 109b. The I/O module 134 typically includes several of such input and output circuits.

The field panel 106b further includes a BAS network communication module 136. The network communication module 136 allows for communication to the controllers 108c and 108e as well as other components on the FLN 110b, and furthermore allows for communication with the workstation 102, other field panels (e.g., field panel 106a) and other components on the BLN 112. To this end, the BAS network communication module 136 includes a first port (which may suitably be a RS-485 standard port circuit) that is connected to the FLN 110b, and a second port (which may also be an RS-485 standard port circuit) that is connected to the BLN 112.

The field panel 106b may be accessed locally. To facilitate local access, the field panel 106b includes an interactive user interface 128. Using user interface 128, the user may control the collection of data from devices such as sensor 109a and actuator 109b. The user interface 128 is operative, configured and/or adapted to both alter and show information regarding the field panel 106b, such as status information, and/or other data pertaining to the operation, function and/or modifications or changes to the field panel 106b.

As mentioned above, the memory 124 includes various programs that may be executed by the processing circuitry/logic 122. In particular, the memory 124 of FIG. 3 includes a BAS application 144 and a BSIS building application 146. The BAS application 144 includes conventional applications configured to control the field panel 106b of the BAS 100 in order to control and monitor various field devices 109a-n of the BAS 100. Accordingly, execution of the BAS application 144 by the processing circuitry/logic 122 results in control signals being sent to the field devices 109a-n via the I/O module 134 of the field panel 106b. Execution of the BAS application 144 also results in the processor 122 receiving status signals and other data signals from various field devices 109a-n, and storage of associated data in the memory 124. In one embodiment, the BAS application 144 may be provided by the Apogee® Insight® BAS control software commercially available from Siemens Industry, Inc. or another BAS control software.

In addition to the instructions 142, the memory 124 may also include data 152. The data 152 may include records 154, graphical views 156, a room database 158, a user database 162, and an equipment database 164. The records 154 include current and historical data stored by the field panel 106b in association with control and operation of the field devices 109a-n. For example, the records 154 may include current and historical temperature information of a particular room of the building 99, as provided by a thermistor or other temperature sensor within the room. The records 154 in the memory may also include various set points and control data for the field devices 109, which may be pre-installed in memory 124 or provided by the user through the user interface 128. The records 154 may also include other information related to the control and operation of the 100 BAS and BSIS building application 146, including statistical, logging, licensing, and historical information.

The graphical views 156 provide various screen arrangements to be displayed to the user via the user interface 128. The user interface 128 may be displayed at thermostats with displays or other user access points having displays, such as liquid crystal displays, light emitting diode displays, or other known types of visual displays devices.

The room database 158 may include data related to the layout of the building 99. This room database 158 includes a unique identifier for each room or area within the building (e.g., room “12345”). In addition to the unique identifier data, the room database 158 may include other information about particular rooms or areas within the building 99. For example, the room database 158 may include information about field devices located within the room or area, particular equipment (e.g., research equipment, manufacturing equipment, or HVAC equipment) positioned within the room or area.

The user database 162 may include data related to human users who frequent the building 99. Accordingly, the user database 162 may include a unique identifier for each human user (e.g., user “12345”) and a user profile associated with that user. In other implementations, each room or area may have a profile that has one or more users associated with it. The user profile may include information provided by the user or provided by third parties about the user. For example, the user profile may include a preferred temperature or lighting level for the user, which is provided to the user database 162 by the user. Also, the user profile may include a security clearance level, room access, or data access for the user, all provided to the database 162 by a third party, such as the human resources department or security department for the employer who owns the building 99.

The equipment database 164 may include data related to various pieces of equipment within the building 99. The equipment may include field devices associated with the BAS 100 or other equipment that is positioned within the building 99. For example, the equipment database 164 may include information related to manufacturing or research equipment located in a particular room of the building. The equipment database 164 maintains a unique identifier for each piece of equipment (e.g., equipment “12345”) and data associated with that equipment. For example, the database 164 may associate particular schematics, operation manuals, photographs, or similar data with a given piece of equipment within the database 164.

While the field panel 106b has been explained in the foregoing embodiment as housing the BSIS building application 146 and various BSIS databases, such as the room database 158, user database 162, and equipment database 164, it will be recognized that these components may be retained in other locations in association with the BAS 100. For example, these components could all be retained within the central workstation 102 of the BAS 100 or a separately designated BSIS computing device in the BAS 100.

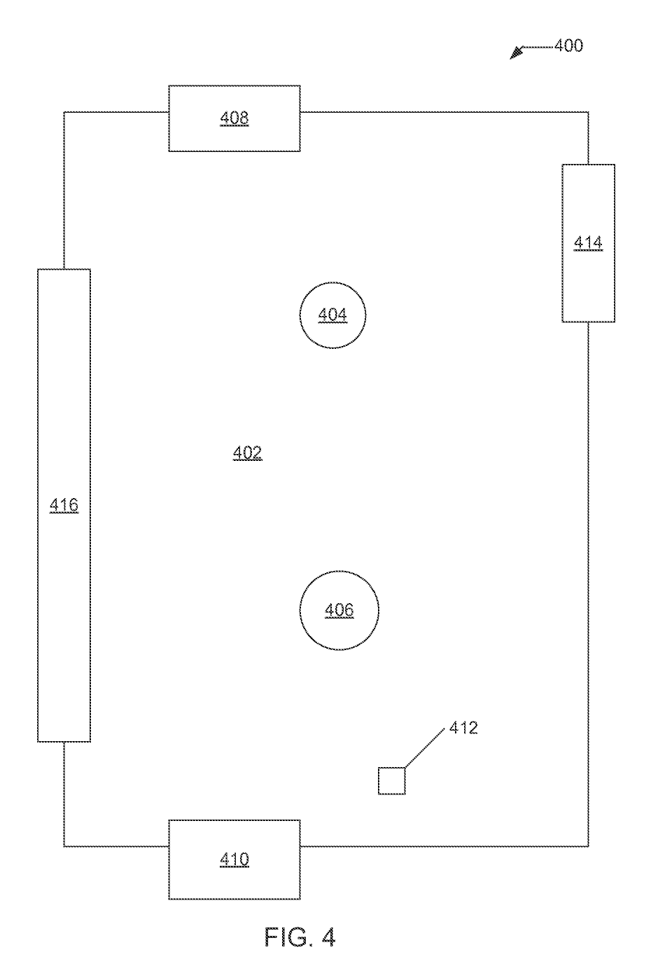

In FIG. 4, a diagram 400 of a room 402 controlled by BAS 100 of FIG. 1 in accordance with an example implementation is depicted. The room 402 is depicted with two lights 404 and 406, an air in-flow vent 408, air exhaust vent 410, thermostat 412, door 414, and window 416. Energy in the form of light and heat enter the room via warm air from the air in-flow vent 408, lights 404 and 406, and from people being in the room. External energy may also enter the room via the window 416 in the form of radiant energy from the sun. This energy entering and exiting the room may be modeled in a room model or building model.

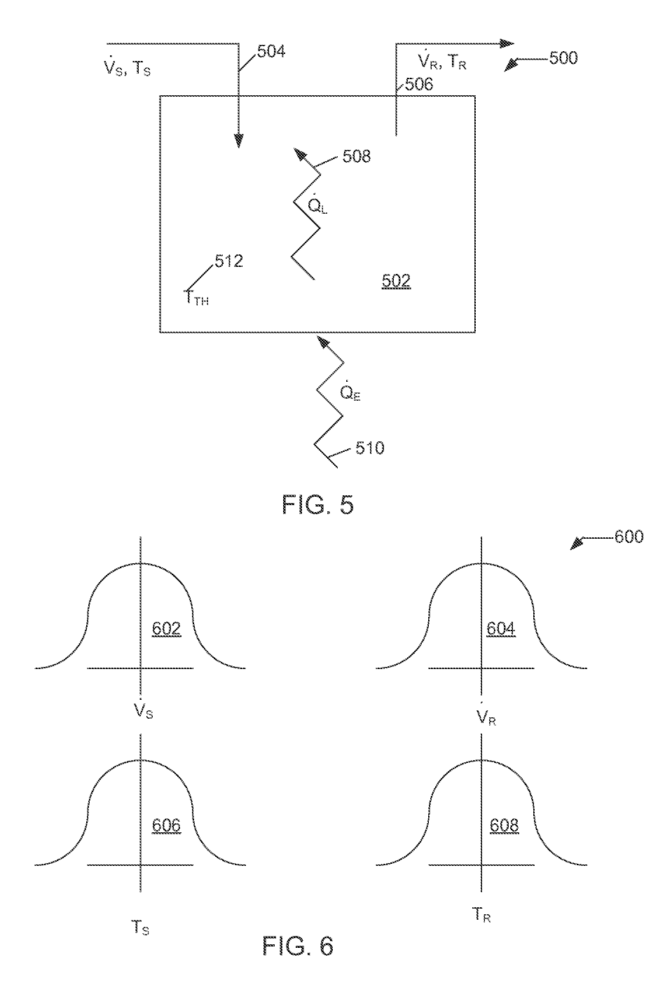

Turning to FIG. 5, a diagram 500 of a room model 502 of room 402 of FIG. 4 is depicted. Energy entering the room model 502 may be characterized as air velocity supply \dot{V}_{S} and temperature supply T_{S} 504. Energy leaving the room may be characterized as air velocity return \dot{V}_{R} and air temperature return T_{R} 506. The heat generated in the room may be represented by \dot{Q}_{L} 508 and the heat entering the room from all other sources such as a window may be represented by \dot{Q}_{E} 510. For purposes of the room model 502, it may be assumed that the temperature of the return air T_{R} is equivalent to the temperature measured via the thermostat 412 T_{TH}. The non-steady state formula for the room model 502 may be expressed as:

$${\dot{E}}_{R} = \frac{d {e}_{R}}{d t} = {E}_{i n} - {\dot{E}}_{out} + {\dot{E}}_{gen}$$

Where Ė_{R} is the energy in the room model 502, Ėᵢₙ is energy entering the room, Ėₒᵤₜ is the energy leaving the room, and Ė_{gen} is energy generated in the room. By substituting in the values from the room model 502, the formula becomes:

$${\dot{E}}_{R} = \frac{d {e}_{R}}{d t} = ( {ρ}_{S} {C}_{P} {\dot{V}}_{S} {T}_{S} + {Q}_{\dot{E}} - {ρ}_{R} {C}_{P} {\dot{V}}_{R} {T}_{R} + {\dot{Q}}_{L} )$$

Where ρ_{S} is the air density of the supply air, C_{P} is the specific heat that together with the air density make up the thermal capacity of the supply air. It is also noted that at steady state

$$\frac{d {e}_{R}}{d t} = 0.$$

This formula may be simplified to:

$${ρ}_{R} {C}_{P} {\dot{V}}_{R} * \frac{d {T}_{TH}}{d t} = ( A )$$

and substituting K_{R} for the value of ρ_{R}C_{P}\dot{V}_{R} the formula becomes:

$${K}_{R} \frac{d {T}_{TH}}{d t} = ρ {C}_{P} ( {\dot{V}}_{S} {T}_{S} - {\dot{V}}_{R} {T}_{R} ) + {Q}_{\dot{U}}$$

With the energy or heat in the room being Q_{\dot{U}}=Q_{Ė}+Q_{\dot{L}} and then:

$$\frac{{K}_{R}}{ρ {C}_{P}} \frac{d T}{d t} - {\dot{V}}_{S} {T}_{S} - {\dot{V}}_{R} {T}_{R} + \frac{{\dot{Q}}_{U}}{{ρ}_{R} {C}_{P}}$$

Further simplifying the equations with

$$\frac{{K}_{R}}{ρ {C}_{P}}$$

being set to a constant K_{B} and the energy generated in the room

$$\frac{{\dot{Q}}_{L}}{{ρ}_{R} {C}_{P}}$$

set to \dot{Q} the equation becomes:

$${K}_{B} \frac{d T}{d t} = {\dot{V}}_{S} {T}_{S} - {\dot{V}}_{R} {T}_{R} + \dot{Q}$$

and at steady state, the equation is:

0=\dot{V}_{S}T_{S}−\dot{V}_{R}T_{R}+\dot{Q}

That is solvable for the steady state of the energy in the room using the measured values of \dot{V}_{S},T_{S},\dot{V}_{R},T_{R}:

\dot{Q}=\dot{V}_{S}T_{S}−\dot{V}_{R}T_{R}

With the room being mathematically modeled, the BAS 100 is able to keep a record of historical data for the variables, such as \dot{V}_{S},T_{S},\dot{V}_{R},T_{R,} or T_{TH,} in addition to additional information, such as time of day, outside temperature, number of people in the room in a statistical knowledge database. This data may then be used to create normalized plots for the variables as they affect the heat or energy “\dot{Q}” in the room. For example, FIG. 6 depicts normalized bell curve plots for \dot{V}_{R} 604, \dot{V}_{S} 602, T_{S} 606 and T_{TH} 608 (which is equivalent to T_{R)}. In other implementations, additional or other variables or parameters may be used to model the room 402 or building.

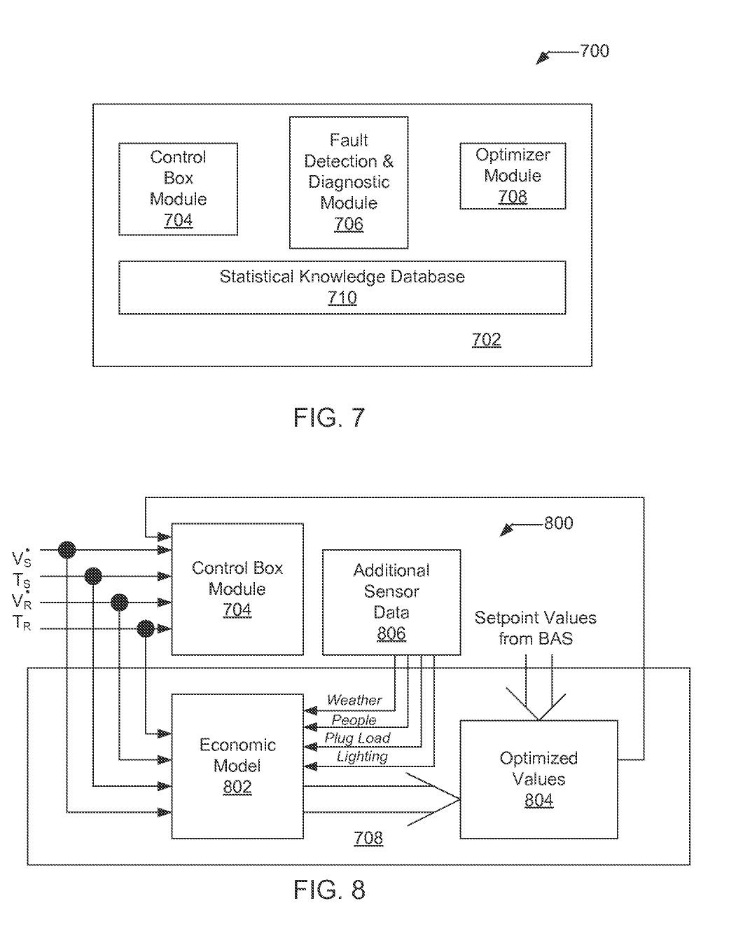

In FIG. 7, a block diagram 700 of a knowledge base module 702 that may reside in the BAS application block 144 of FIG. 3 is illustrated. A control box module 704 receives data from current room sensing devices and the desired set points from the BAS, and then calculates new valve/actuator damper positions that are sent to the respective room devices. Current room data may include \dot{V}_{S} and \dot{V}_{R} and T_{S} and T_{R} for calculating Ė_{R} as well as other sensed values. Fault Detection and Diagnostic Module 706 (FDD Module) applies the room sensed data, room valve/damper actuator data, and any additional sensor data for detecting operational errors within the equipment. If abnormal operation is detected, the FDD module 706 informs the BAS 100 of such abnormal operation, typically by sending a fault or error message. Optimizer Module 708 may also use room sensed data and any additional sensed data as well as desired set points from the BAS to modify the set point values supplied to Control Box Module 704.

The Statistical Knowledge Database 710 gathers the sensed room data and builds statistical knowledge databases for each sensed value. Unlike the “instantaneous” sensed values, the statistics-based summary values are based on all values over a longer period of time. In one implementation of the statistical knowledge, these longer term point data would each be represented as a Bell Curve (FIG. 6) with a Mean (center line) and a standard deviation (Bell Curves are usually drawn with + and −3 Standard Deviation widths or 6 total). Standard Deviation is in the same units as the process variable and the mean value. In operation, one typically wants to test where an instantaneous value is with respect to the long term data. This can be done by subtracting the instantaneous value from the process mean, then dividing that difference by the standard deviation, resulting in a value known to statisticians as a Z-score. The closer the Z-score is to 0, the closer the value is to the mean. Likewise the larger the Z-score, the farther the instantaneous value is from the process mean (and the more likely something may be wrong). The BAS could set limits for the Z-score value and cause an alarm if value exceeded, implying that the process variable is now operating outside of its known historical region. These and other statistical knowledge base information are supplied to modules 704, 706, and 708 to assure their respective values are within tolerances. It can be realized by those skilled in the art that the Statistical Knowledge Database 710 may track different time intervals (hour, day, week, month, quarter, season, and or year) for sets of statistical results and for fault filtering and may report these results in a form other than a Bell Curve.

The statistical knowledge base module 702 may also have an optimizer module 708 associated with it or incorporated into it. The optimizer module 708 may have an economic model that relates the parameters from the room model 502 to costs. The economic module formula may be expressed as:

$=f(\dot{V}_{S},T_{S},\dot{V}_{R},T_{R})

when at steady state:

$$\frac{d \$}{d ( {\dot{V}}_{S} , {T}_{S} , {\dot{V}}_{R} , {T}_{R} )} = 0$$

Therefore, the use of the above formulas with a cost factor or cost constant enables a cost model to be created.

Turning to FIG. 8, a block diagram 800 of the optimizer module 708 having control box module 704 of FIG. 7 is depicted. Control box module 704 may receive additional sensor data 806 supplied by the BAS 100 that includes number of people, plug load, and lighting making up the \dot{Q}_{L} 508 of FIG. 5 and weather making up the \dot{Q}_{E} 510, FIG. 5. Optimizer module 708 is shown as having economic model 802 and optimized values 804, where the economic model 802 is configured to calculate economic impact of control decisions (generated set point offsets) based on the amount of energy and energy cost required for equipment associated with the room and to calculate set point offsets for overall minimum energy usage and cost. Optimized values 804 receives set point values 810 from the BAS 100, adds the economic model offsets (set of point offsets) 812 to each respective set point and supplies these optimized values back to control box module 704 and the BAS 100, thus enabling the control box model 704 to use optimized set point values 808 associated with the minimum energy while maintaining user comfort.

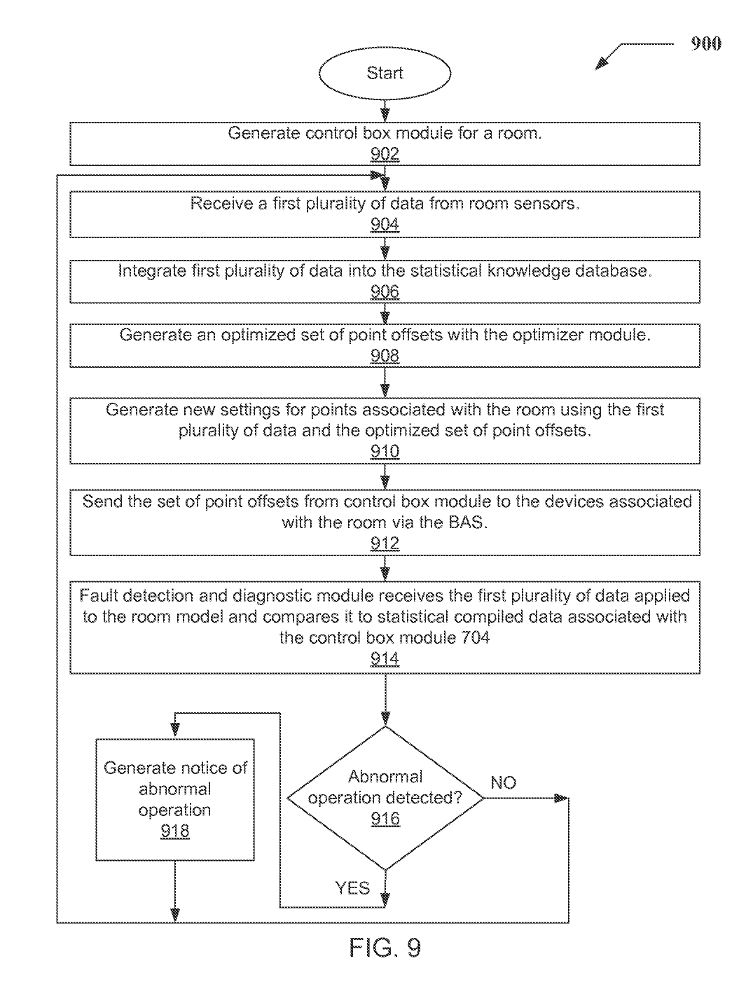

Turning now to FIG. 9, a flow diagram 900 of the approach for generating optimized values for room 402 using the room model 502 and economic model 802 by the knowledge base module 702 is depicted. A control box module 704 is generated or created for room 402 in step 902. A plurality of data from room sensors in the BAS 100 is received at the knowledge base module 702 in step 904. In step 906, the first plurality of data is integrated into the statistical knowledge database 710 and output values are updated using the first plurality of data for use by the other modules (704, 706, and 708). The optimizer module 708, in step 908, may receive or otherwise access the first plurality of data and calculates an optimized set of point offsets. The optimizer may use the economic model 802 when optimizing the point offsets. The control box module 704 may then use the first plurality of data and the optimized set of point offsets to generate new valve/damper actuator positions (adjust the points associated with room 402) in step 910. The control box module 704 may transmit the new actuator positions to the BAS which in return forwards them to the devices in step 912. The fault detection and diagnostics module 706 may also receive the first plurality of data and compares the associated room model data associated with the first plurality of data to statistical compiled data for the room model as implemented in the control box module 704 in step 914. If abnormal operation is detected in decision step 916, a notice may be generated by the fault detection and diagnostic module 706 and sent to the BAS 100 in step 918. If no abnormal operation is detected in decision step 916, another set of data may be received from the room sensors (step 904). It is clear to those skilled in the art that alternative sequences or concurrent sequences of operations could be executed due to timing or resource requirements but would still be within the scope of this explanation.

It will also be understood, and is appreciated by persons skilled in the art, that one or more modules, processes, sub-processes, or process steps described in connection with FIGS. 7 and 9 may be performed by hardware and/or software (machine readable instructions). If a server is described (OMC may be implemented as a server), the term “server” may mean a combination of hardware and software operating together as a dedicated server or it may mean software executed on a server to implement the approach previously described. If the process is performed by software, the software may reside in software memory (not shown) in a suitable electronic processing component or system such as one or more of the functional components or modules schematically depicted in the figures.

The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any tangible means that may contain or store the program for use by or in connection with the instruction execution system, apparatus, or device. The tangible computer-readable medium may selectively be, for example, but is not limited to, an electronic, magnetic, optical, electromagnetic, infrared, or semiconductor system, apparatus or device. More specific examples, but nonetheless a non-exhaustive list, of tangible computer-readable media would include the following: a portable computer diskette (magnetic), a random access memory (RAM) (electronic), a read-only memory (ROM) (electronic), an erasable programmable read-only memory (EPROM or Flash memory) (electronic) and a portable compact disc read-only memory (CDROM) (optical). Note that the computer-readable medium may even be paper (punch cards or punch tape) or another suitable medium upon which the instructions may be electronically captured, then compiled, interpreted or otherwise processed in a suitable manner if necessary, and stored in a computer memory.

The foregoing detailed description of one or more embodiments of the integration of building information models and building automation systems has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

1. A building automation system (BAS) (100), comprising:
a first plurality of data (904) associated with a room (402) received by a processor (122) in the BAS (100) having a first set of point values (810) for the room (402);
a room model (502) for the room (402) stored in a memory (124) coupled to the processor (122), where the first plurality of data (904) is applied to the room model (502) and the results integrated into a database (710) stored in memory (124); and
an optimized set point (808) settings generated from an optimized set of point offsets (812) identified by an optimizer module (708) controlled by the processor (122) using the first set of point values (810) and the optimized set of point offsets (812).

2. The BAS (100) of claim 1, includes:
a fault detection and diagnostic module (706) controlled by the processor (122) that is in receipt of the first plurality of data (904) applied to the room model (502) and compares it to statistical data (710) associated with the room model (502); and
a message generated by the fault detection and diagnostic module (706) in response to the comparison of the statistical data (710) with the room model (502) that indicates abnormal operation.

3. The BAS (100) of claim 1, where the optimizer module (708) further includes an economic model (802) that receives the first plurality of data (904) and generates the optimized (908) values based upon at least one economic priority.

4. The BAS (100) of claim 3, where the economic priority is energy use.

5. The BAS (100) of claim 3, where the economic priority is energy cost.

6. The BAS (100) of claim 3, includes additional sensor data (806) that is applied to the economic model (802) in addition to the first plurality of data (904).

7. The BAS (100) of claim 6, where the additional sensor data (806) includes at least weather data.

8. A method of adjusting a building automation system (BAS) (100), comprising:
receiving a first plurality of data (904) associated with a room (402) in the BAS (100) that has a first set of point values (810) for the room (402);
storing a room model (502) for the room (402) in a memory (124) coupled to a processor (122);
applying the first plurality of data (904) to the room model (502) and integrating the results of the first plurality of data (904) applied to the room model (502) into a database (710) stored in the memory (124);
identifying an optimized set of point offsets (812) by an optimizer module (708) using the first set of point values (810) and the optimized set of point offsets (812); and
generating by the optimizer module (708), an optimized set of point settings 808.

9. The method of adjusting a BAS (100)of claim 8, includes:
receiving at a fault detection and diagnostic module (706) controlled by a processor (122) the first plurality of data (904) applied to the room model;
comparing the first plurality of data (904) applied to the room model (502) to statistical data (710) associated with the room model (502); and
generating a message by the fault detection and diagnostic module (706) in response to the comparison of the statistical data (710) with the room model (502) that indicates abnormal operation.

10. The method of adjusting the BAS (100) of claim 9, where the optimizer module (708) further includes, receiving at an economic model (802) the first plurality of data (904); and
generating the optimized values (804) based upon at least one economic priority.

11. The method of adjusting the BAS (100) of claim 10, where the economic priority is energy use.

12. The method of adjusting the BAS (100) of claim 10, where the economic priority is energy cost.

13. The method of adjusting the BAS (100) of claim 10, includes additional sensor data (806) that is applied to the economic model (802) in addition to the first plurality of data (904).

14. The method of adjusting the BAS (100) of claim 13, where the additional sensor data (806) includes at least weather data.

15. A tangible computer-readable medium with a plurality of machine readable instructions, that when executed, perform a method of adjusting a building automation system (BAS) (100), comprising:
receiving a first plurality of data (904) associated with a room (402) in the BAS (100) that has a first set of point values (810) for the room (402);
storing a room model (502) for the room (402) in a memory (124) coupled to the processor (122);
applying the first plurality of data (904) to the room model (502) and integrating the results of the first plurality of data (904) applied to the room model (502) into a database (710) stored in the memory (124);
identifying an optimized set of point offsets (812) by an optimizer module (708) using the first set of point values (810) and the optimized set of point offsets (812); and
generating by the optimizer module(708), an optimized set of point settings(808).

16. The tangible computer-readable medium with a plurality of machine readable instructions, that when executed, perform a method of adjusting the BAS (100) of claim 15, includes:
receiving at a fault detection and diagnostic module (706) controlled by a processor (122) the first plurality of data (904) applied to the room model (502);
comparing the first plurality of data (904) applied to the room model (502) to statistical data (710) associated with the room model (502); and
generating a message by the fault detection and diagnostic module (706) in response to the comparison of the statistical data (710) with the room model (502) that indicates abnormal operation.

17. The tangible computer-readable medium with a plurality of machine readable instructions, that when executed, perform a method of adjusting the BAS (100) of claim 15, where the generating by the optimizer module (708) further includes, receiving at an economic model (802) the first plurality of data (904); and
generating the optimized values (804) based upon at least one economic priority.

18. The tangible computer-readable medium with a plurality of machine readable instructions, that when executed, perform a method of adjusting the BAS (100) of claim 17, where the economic priority is energy use.

19. The tangible computer-readable medium with a plurality of machine readable instructions, that when executed, perform a method of adjusting the BAS (100) of claim 17, where the economic priority is energy cost.

20. The tangible computer-readable medium with a plurality of machine readable instructions, that when executed, perform a method of adjusting the BAS (100) of claim 17, includes additional sensor data (806) that is applied to the economic model (802) in addition to the first plurality of data (904).

21. The tangible computer-readable medium with a plurality of machine readable instructions, that when executed, perform a method of adjusting the BAS (100) of claim 20, where the additional sensor data (806) includes at least weather data.
